(19) United States
(12) Patent Application Publication
(10) Pub. No.: US 2013/0258089 A1
(43) Pub. Date: Oct. 3, 2013

(54) Eye Gaze Based Image Capture

(71) Applicants: Kenton M. Lyons, Santa Clara, CA (US); Joshua J. Ratcliff, San Jose, CA (US)

(72) Inventors: Kenton M. Lyons, Santa Clara, CA (US); Joshua J. Ratcliff, San Jose, CA (US)

(73) Assignee: Intel Corporation, Santa Clara, CA (US)

(21) Appl. No.: 13/993,717

(22) PCT Filed: Nov. 3, 2011
(86) PCT No.: PCT/US11/59159

§ 371 Date: Jun. 13, 2013

(51) Int. Cl. H04N 5/232

(52) U.S. Cl. CPC H04N 5/23212
USPC 348/77

(57) ABSTRACT

Gaze detection technology may be used to aim aimable optics on an imaging device. As a result, the user need not do anything more to direct the camera's line of sight than to look at something. In some embodiments, the camera may then adjust the focus and exposure based on the gaze target. In addition, the camera may keep track of how long the user looks at a given area within a scene and, if a time threshold is exceeded, the camera may zoom in to that gaze target.

### BACKGROUND

This relates generally to image capture, including photography and moving picture image capture.

Typically, a user uses a viewfinder to frame a picture. Thus, when the user adjusts the settings on the camera, the picture the user wants to take is determined from the image the user sees in the viewfinder. Generally, autofocusing cameras automatically focus on some object in the viewfinder. Of course, the problem is that when there are many objects at different depths of field, the selection of a particular depth of field in automatic focus adjustments tends to be somewhat arbitrary.

### BRIEF DESCRIPTION OF THE DRAWINGS

FIG. 1 is a schematic depiction of one embodiment of the present invention;

FIG. 2 is an example of a photograph captures pursuant to the set up shown in FIG. 1 in accordance with one embodiment;

FIG. 3 is a flow chart for one embodiment of the present invention;

FIG. 4 is an imaging device in accordance with one embodiment of the present invention;

FIG. 5 is a flow chart for another embodiment;

FIG. 6 is a schematic depiction of a wearable system in accordance with one embodiment; and

FIG. 7 is a depiction of an embodiment wherein the wearable system includes eye glasses.

### DETAILED DESCRIPTION

In accordance with some embodiments, gaze detection technology may determine what a person wishing to capture an image is looking at. By knowing what the person is looking at, one or more of the composition of the picture, the depth of focus of the camera, the camera focus, the exposure, or the area captured may be controlled in some embodiments of the present invention.

In some embodiments, the eye gaze detection technology may be part of the viewfinder. Namely, when the user is looking in the viewfinder, eye gaze detection can determine what the user is looking at and may adjust the camera image capture characteristics to attempt to capture, in the best focus, that which the user is looking at. Thus, when there are a number of objects within the scene being imaged within the viewfinder, the object that is placed in focus, in some embodiments, is that object which it is determined the user is actually looking at within the viewfinder. In other embodiments, the viewfinder may be dispensed with and the camera aimed and directed in accordance with the target of the user's gaze using eye tracking or gaze detection technology.

As used herein, eye tracking, gaze detection, and head tracking software are referred to collectively as gaze detection technology. In gaze detection technology, what the user is looking at is identified and this identification can then be used to control the image capture process.

In a typical embodiment, the most important factor may be to choose from among different objects depicted in a potential image captured scene, that object which is actually the target of the user's interest. In this way, that object may govern the depth of field of the picture and that object may be placed in the best possible focus among the plurality of objects at different depths within the image scene. In addition, exposure settings may be based on what the user is looking at and, in fact, the optics of the camera, in some embodiments, may actually be aimed based on what the user is looking at.

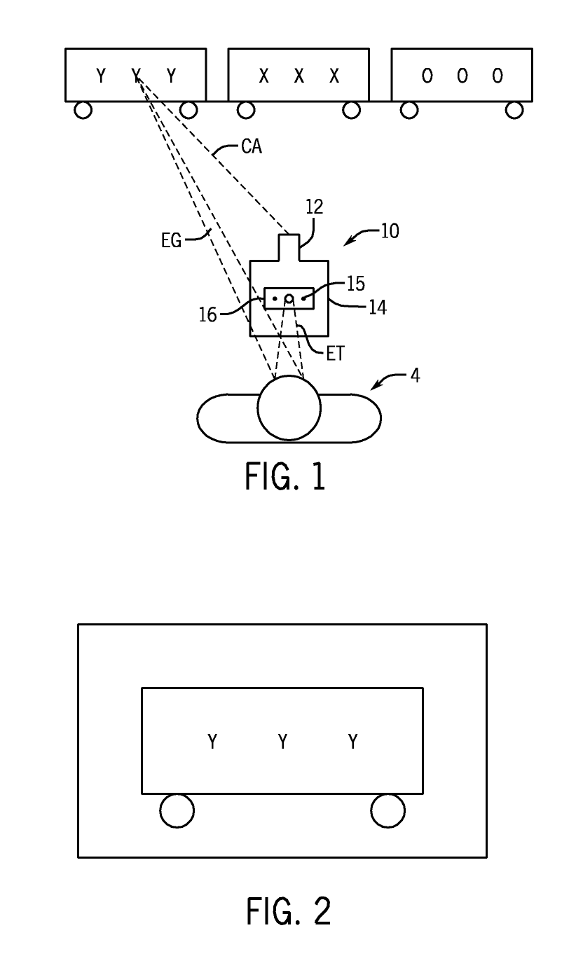

Thus, referring to FIG. 1, a user is using a camera 10, with a housing 14, to image a train which includes cars 000, XXX, and YYY. The camera lens 12 may have a line of sight CA to the train car YYY. Likewise, the user's gaze, indicated by the lines EG may be at the same place. In some embodiments, the gaze detection technology 16 may image the user's eyes, as indicated by the line of sight ET and may determine that the user is looking at the train car YYY and may adjust the lens 12 to aim at the car YYY and to adjust the focus to the distance to YYY, as well as setting the exposure and any other settings at the same target.

In one embodiment, the lens 12 may be gimbal-mounted. The lens line of sight may be adjusted by computer controlled servo motors (not shown), in one embodiment.

Thus, as shown in FIG. 2, the resulting image is an image of the car YYY centered in the depiction. In some cases, the user need not actually aim the camera 10 at the intended target, but, instead, the optics may be adjusted to capture the target of the user's eye gaze in focus, with proper exposure, and centered within the captured image frame. This may be done automatically without the user having to do anything but look at the intended target.

In some embodiments, a calibration sequence may be used to cause the gaze detection technology to correlate with the optics 12 of the camera 10. Once the gaze detected direction is synchronized with the lens optics, the lens optics should follow the user's gaze without the user necessarily having to turn the camera towards the intended imaging target.

In some embodiments, the gaze detection technology 16 may be a movie camera that tracks the user's head, eyes, or face direction. For example, infrared light may be directed at the user's face from an upward facing camera 16 on the top of the camera 10, housing 14. That upward facing camera 16 may be associated with light emitting diodes 15 that emit infrared light reflected from the user's eyes. Those reflections are used to track the user's gaze. Other gaze detection techniques include electromyography (EMG) based eye tracking technology.

In some embodiments, the eye tracking technology may be part of the camera. For example, as depicted in FIG. 1, it may include an upwardly angled camera 16 mounted on top of the camera 10. In other embodiments, it may be mounted within the camera as part of the viewfinder. In still other embodiments, it may be separate from the camera. For example, it may be associated with glasses or other head mounted imaging apparatus to determine what the user is looking at.

In some cases, some parallax adjustment may be needed when the camera is not closely adjacent to the user's eyes. However, as is the case in conventional gaze tracking technology, such parallax adjustments may be made automatically. Moreover, if desired, the distance and orientation of the camera 16, with respect to the user's eyes, may be determined using conventional distance detection technology. Similarly, positioning technology may determine the position of the user's eyes, as recognized by a proximate sensor and the position of the camera 16, as determined by a position sensor within the camera 16.

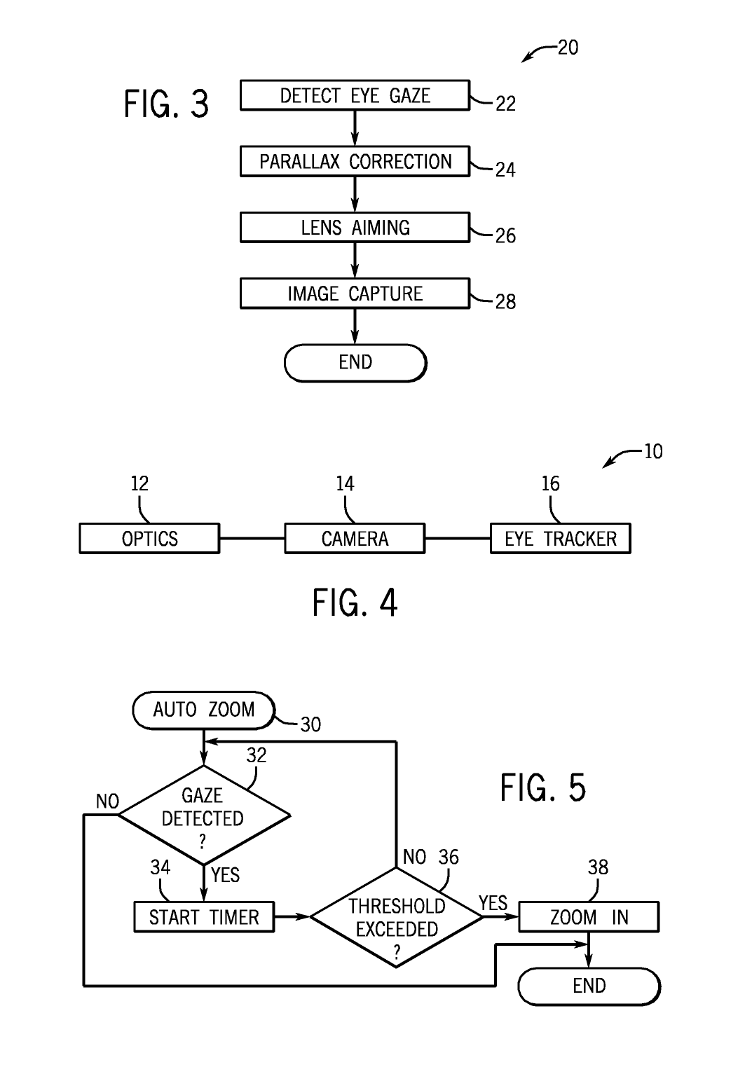

Thus, referring to FIG. 3, a sequence 20 may be implemented using software, hardware, and/or firmware. In software or firmware embodiments, the sequence may be implemented using computer executed instructions stored in a non-transitory computer readable medium, such as a semiconductor, optical, or magnetic storage device.

The sequence 20, shown in FIG. 3, may begin by detecting the user's gaze direction using gaze detection technology. Once the user's eye gaze direction is determined, as indicated in block 22, a parallax correction may be implemented if desired, as indicated in block 24. The parallax correction accounts for the difference between the line of sight between the user's eyes, indicated by the lines EG in FIG. 1, and the line of sight from the camera 10 to the same target, indicated as CA in FIG. 1. In other embodiments, parallax correction may not be needed.

Then, in some embodiments, the lens 12 may be aimed, as indicated at 26, to correspond to the user's gaze direction. In addition, exposure settings and focus settings may be set to present the target of the user's eye gaze in the best possible focus and exposure. Finally, once the camera focus, exposure settings, and direction of sight, as well as framing of the picture, has been achieved based on the detected eye gaze, image capture may be implemented, as indicated in block 28.

Turning to FIG. 4, in an embodiment in which the eye gaze detection is part of the camera 10, itself, the imaging device 14 may include aimable optics 12. An eye tracker 16 may be associated with the camera, for example the viewfinder. In such case, based on what the user is looking at, the line of sight of the optics 12 may be adjusted. The optics 12 may be adjusted as simply as adjusting the depth of focus, in some embodiments. In other embodiments, the amount of exposure and the area of exposure may be controlled. In more advanced embodiments, the optics may actually track what the user is looking at.

In some embodiments, not only is it known what the user is looking at at any instance of time, but what the user has looked at over a period of time is also known. For example, if it is known that the user has looked at a small area within the scene over a period of time, it may be possible to zoom in to that particular scene for image capture.

In some cases, objects within the image may be automatically subjected to image recognition techniques. Once the image object is identified, it may be used to focus the depiction to that particular object.

For example, if the user is looking at a complex scene of oceans, mountains, and a boat, if it is determined that the user has been focusing on the boat for some period of time in excess of a threshold, the optics 12 may zoom to capture primarily the boat and to reduce the amount of imaged area that is devoted to the mountains and ocean. Similarly, the depth of field may be adjusted to correspond to the location of the boat. Likewise, the exposure setting may be optimized for the particular boat. Thus, the size of objects within the display may be adjusted based on the user's focus and, particularly, what the user has gazed at over time.

Thus, referring to FIG. 5, a sequence 30 may be implemented in software, hardware, and/or firmware. In software and firmware embodiments, the sequence may be implemented in computer executed instructions stored in a non-transitory computer readable medium, such as an optical, magnetic, or semiconductor storage.

The sequence begins at diamond 32 by determining whether the user's gaze direction has been detected. If so, a timer is started in block 34. If a threshold is exceeded, as determined in diamond 36, then an automatic zoom in may be implemented (block 38) to zoom into the area where the user's focus has remained for a time in excess of the threshold. In this way, automatic zooming can be used to capture that region that is of most interest to the user.

Similarly, if, over time, the user is looking at a number of different objects within the scene before the exposure is taken, the scene may be framed to include all of those objects. In some cases, a number of images may be captured over time and an image is selected that corresponds most closely to what the user is currently looking at and has been looking at over a period of time. In some embodiments, a time threshold or the period of analysis of what the user is looking at may be adjustable by the user.

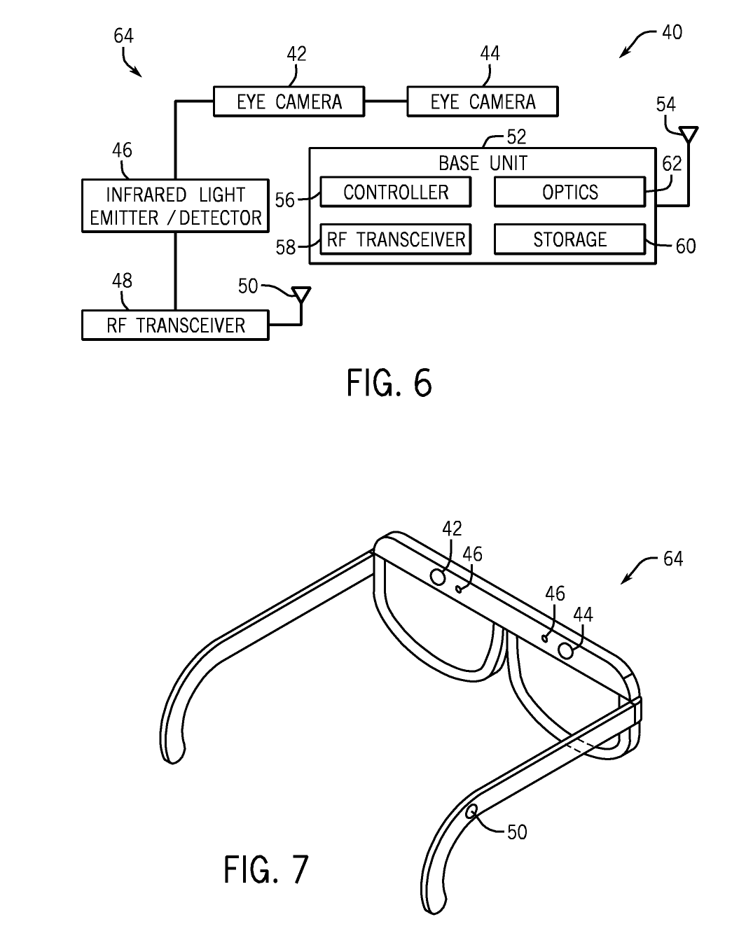

In accordance with another embodiment, shown in FIG. 6, a wearable unit in the form of eye glasses 64, shown in FIG. 7, may include a pair of eye cameras 42 and 44, one for each eye, mounted on the bridge of the glasses in order to image the user's eyes. Adjacent each camera, in one embodiment, may be infrared emitter/detectors 46. The emitter/detectors in the eye cameras 42 and 44 may be coupled to a radio frequency (RF) transceiver 48, mounted over the user's ear, as indicated in FIG. 7. The RF transceiver may include an antenna 50 which communicates over short range wireless communications with an antenna 54 in a base unit 52. The base unit 52 may be carried by the user and may have the appearance and/or function of a conventional cell phone or camera. The base unit 52 may include a controller 56 for controlling its operations, an RF transceiver 58, coupled to the antenna 54, steerable optics 62 to track the user's gaze direction (as determined by the glasses mounted unit 64) and a storage 60.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using gaze detection technology to aim an imaging device.

2. The method of claim 1 including implementing an automatic zoom based on an amount of time that a user has looked at a target area within a scene.

3. The method of claim 1 including using gaze detection technology mounted on an imaging device.

4. The method of claim 3 including using a wearable camera mounted on said imaging device as part of said gaze detection technology.

5. The method of claim 1 including adjusting at least one of focus or exposure based on a target identifier by said gaze detection technology.

6. A method comprising:
implementing an automatic zoom based on an amount of time that a user has looked at a target area within a scene.

7. The method of claim 6 including using gaze detection technology to aim an imaging device.

8. The method of claim 6 including, after detecting the target of the user's gaze, determining the amount of time that the user looks at that target.

9. The method of claim 8 including determining whether the time exceeds a threshold and, if so, zooming in to the area where the user is looking.

10. The method of claim 8 including adjusting the focus based on a user's gaze.

11. A non-transitory computer readable medium storing instructions that are executed to enable a computer to:
aim an imaging device using gaze detection technology.

12. The medium of claim 11 further storing instructions to implement automatic zoom based on what the user is looking at.

13. The medium of claim 11 further storing instructions to adjust focus based on what the user is looking at.

14. The medium of claim 11 further storing instructions to adjust exposure based on what the user is looking at.

15. An apparatus comprising:
an imaging device;
aimable optics for said imaging device; and
gaze detection technology to aim said optics.

16. The apparatus of claim 15 wherein said apparatus is a camera.

17. The apparatus of claim 15 wherein said apparatus includes a cellular telephone.

18. The apparatus of claim 15 wherein said apparatus is wearable.

19. The apparatus of claim 18 wherein said apparatus includes eye glasses.

20. The apparatus of claim 15, said gaze detection technology to implement an automatic zoom.

21. The apparatus of claim 20 wherein said automatic zoom responds to what the user has looked at over a period of time.

22. The apparatus of claim 15, said gaze detection technology to control focus.

23. The apparatus of claim 15 including said gaze detection technology to control exposure.
